(19) United States
(12) Patent Application Publication
(10) Pub. No.: US 2007/0264122 A1
(43) Pub. Date: Nov. 15, 2007

(54) Blower

(75) Inventors: Takahiro Iwasaki, Kariya-city (JP); Kazuhiro Takeuchi, Okazaki-city (JP); Takuya Usami, Kariya-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/801,095

(22) Filed: May 8, 2007

(30) Foreign Application Priority Data
May 9, 2006 (JP) 2006-129760
Aug. 3, 2006 (JP) 2006-211716

(51) Int. Cl. F03D 1/02

(52) U.S. Cl. 416/120

(57) ABSTRACT

A blower includes two contrarotating axial fans located to be rotated reversely with each other in accordance with rotations of its rotation shafts arranged on an axial line. In the blower, a rotation drive shaft of a motor is coupled to the rotation shafts of the axial fans through a gear portion, and the gear portion is housed in a gear box. Each of the axial fans includes a boss portion having a recess shape opened in an axial direction of the axial fan, and a plurality of blades located radial outside of the boss portion. Furthermore, the axial fans are located such that the recess shapes of the boss portions are opposite to each other, and the gear box is located between the boss portions of the axial fans, and is covered by the boss portions from two sides in an air flow direction of the axial fans.

### CROSS REFERENCE TO RELATED APPLICATION

This application is based on Japanese Patent Applications No. 2006-129760 filed on May 9, 2006 and No. 2006-211716 filed on Aug. 3, 2006, the contents of which are incorporated herein by reference in its entirety.

### BACKGROUND OF THE INVENTION

1. Field of the Invention

The present invention relates to a blower having at least one axial fan. For example, the present invention can be suitably applied to a contrarotating blower having two axial fans rotating reversely with each other.

2. Description of the Related Art

JP-A-2002-310097 describes a blower having an axial fan for sending cool air to a heat exchanger such as a radiator mounted on a vehicle. However, in the blower having the axial fan, because the dynamic pressure of a rotating component part with rotation of the axial fan becomes loss, an axial component part with the rotation of the axial fan is reduced thereby reducing fan efficiency.

In order to increase the fan efficiency, a contrarotating blower having plural axial fans (e.g., two contrarotating axial fans) can be used, and plural fan motors are connected to rotation shafts of the plural axial fans, respectively. In this case, however, the number of components of the blower is increased, and the size and weight of the entire blower become large.

In view of this problem, JP-U-62-112470 describes a blower for a vehicle, having a single fan motor for rotating plural axial fans. In this blower, the rotation drive shaft of the single fan motor is connected to rotation shafts of the axial fans via gear portions. However, when the blower is mounted on a vehicle, foreign materials such as water, spattered stones and dust may be easily entered to the gear portions, thereby affecting rotation function of the gear portions.

### SUMMARY OF THE INVENTION

In view of the foregoing problems, it is an object of the present invention to provide a blower having at least one axial fan rotated by a motor through a gear portion, which can restrict foreign materials from entering to the gear portion.

It is another object of the present invention to provide a blower having two contrarotating axial fans rotated by a motor through a gear portion, which can effectively reduce foreign materials from entering to the gear portion.

According to an aspect of the present invention, a blower includes: two contrarotating axial fans which are located to be rotated reversely with each other in accordance with rotations of its rotation shafts arranged on an axial line, a motor for rotating the axial fans, a gear portion through which a rotation drive shaft of the motor is coupled to the rotation shafts of the axial fans, and a gear box in which the gear portion is housed. In the blower, each of the axial fans includes a boss portion having a recess shape opened in an axial direction of the axial fan, and a plurality of blades located radial outside of the boss portion. Furthermore, the axial fans are located such that the recess shapes of the boss portions are opposite to each other, and the gear box is located between the boss portions of the axial fans and is covered by the boss portions from two sides in an air flow direction of the axial fans.

Because the gear portion is housed in the gear box and the gear box is covered by the boss portions from two sides, it can effectively restrict foreign materials from entering into the gear portion within the gear box.

The rotation drive shaft of the motor may be located between the axial fans and may extend perpendicularly to the axial line of the rotation shafts of the axial fans. For example, the gear portion includes a main gear connected to the rotation drive shaft of the motor, and two driven gears that are engaged with the main gear and connected to the rotation shafts of the axial fans. In this case, the driven gears may be engaged with the main gear so as to rotate the axial fans reversely with each other.

Each of the boss portions may be spaced from the rotation drive shaft to have a first clearance between an end portion of the boss portion and the rotation drive shaft. In this case, the first clearance may be larger than 0 and may be equal to or smaller than 10 mm. Furthermore, the first clearance may be approximately in a range between 3 mm and 6 mm. Alternatively, each of the boss portions may be spaced from the gear box to have a second clearance between the boss portion and the gear box. In this case, the second clearance may be larger than 0 and may be equal to or smaller than 10 mm. Furthermore, the second clearance may be approximately in a range between 3 mm and 6 mm.

At least one protrusion wall portion may be located around the rotation shaft of the axial fan to protrude approximately in a circular shape from at least one of the boss portion and the gear box toward the other one of the boss portion and the gear box. In this case, a labyrinth structure, in which a passage is bent to have at least one bent portion, is constructed with the protrusion wall portion, thereby effectively reducing foreign materials entering to the gear portion.

According to another aspect of the present invention, a blower includes at least one axial fan, a motor for driving and rotating the axial fan, a gear portion through which a rotation drive shaft of the motor is coupled to a rotation shaft of the axial fan, a gear box for housing the gear portion and having a through hole for penetrating through the rotation drive shaft, and a cover plate located to the rotation drive shaft to cover the through hole while being separated from the through hole of the gear box in an axial direction of the rotation drive shaft. Because the cover plate is located to cover the through hole of the gear box, the cover plate effectively reduces foreign material entering into the gear box through the through hole.

A protrusion wall may be provided on the gear box to protrude approximately in a circular shape around the through hole from the gear box toward the cover plate. The cover plate may have a through hole for penetrating through the rotation drive shaft. In this case, the rotation drive shaft may have a groove portion at a position corresponding to the through hole of the cover plate, and the groove portion of the rotation drive shaft may be engaged with the through hole of the cover plate so as to fix the cover plate to the rotation drive shaft. Alternatively, the rotation drive shaft may have a first groove portion at a position corresponding to the through hole of the cover plate, and at least one second groove portion at an axial position different from the first groove portion. In this case, the second groove portion has the same shape as the first groove portion, and the first groove portion of the rotation drive shaft is engaged with the through hole of the cover plate so as to fix the cover plate to the rotation drive shaft.

Furthermore, the at least one axial fan may be constructed with two contrarotating axial fans having its rotation shafts arranged on the same axial line.

### BRIEF DESCRIPTION OF THE DRAWINGS

Additional objects and advantages of the present invention will be more readily apparent from the following detailed description of preferred embodiments when taken together with the accompanying drawings. In which:

FIG. 1 is a disassembled perspective view showing contrarotating blowers and a fan shroud, according to a first embodiment of the present invention;

FIG. 2 is a schematic sectional view showing the contrarotating blower according to the first embodiment;

FIG. 3 is a disassembled perspective view showing contrarotating blowers and a fan shroud, according to a second embodiment of the present invention;

FIG. 4 is a schematic sectional view showing the contrarotating blower according to the second embodiment;

FIG. 5 is an enlarged view showing a part of the blower, indicated by V in FIG. 3;

FIG. 6 is a partial sectional top view showing gear boxes and a rotation drive shaft according to the second embodiment;

FIG. 7 is a perspective view showing a cover plate for preventing foreign material from entering, according to the second embodiment;

FIG. 8 is a perspective view showing a rotation drive shaft of the blower according to the second embodiment;

FIG. 9 is a partial sectional top view showing a gear box and a rotation drive shaft according to a third embodiment of the present invention;

FIG. 10 is a partial sectional top view showing a gear box and a rotation drive shaft according to a third embodiment of the present invention; and

FIG. 11 is a partial sectional top view showing a gear box and a rotation drive shaft according to a fourth embodiment of the present invention.

### DETAILED DESCRIPTION OF THE PREFERRED EMBODIMENTS

### First Embodiment

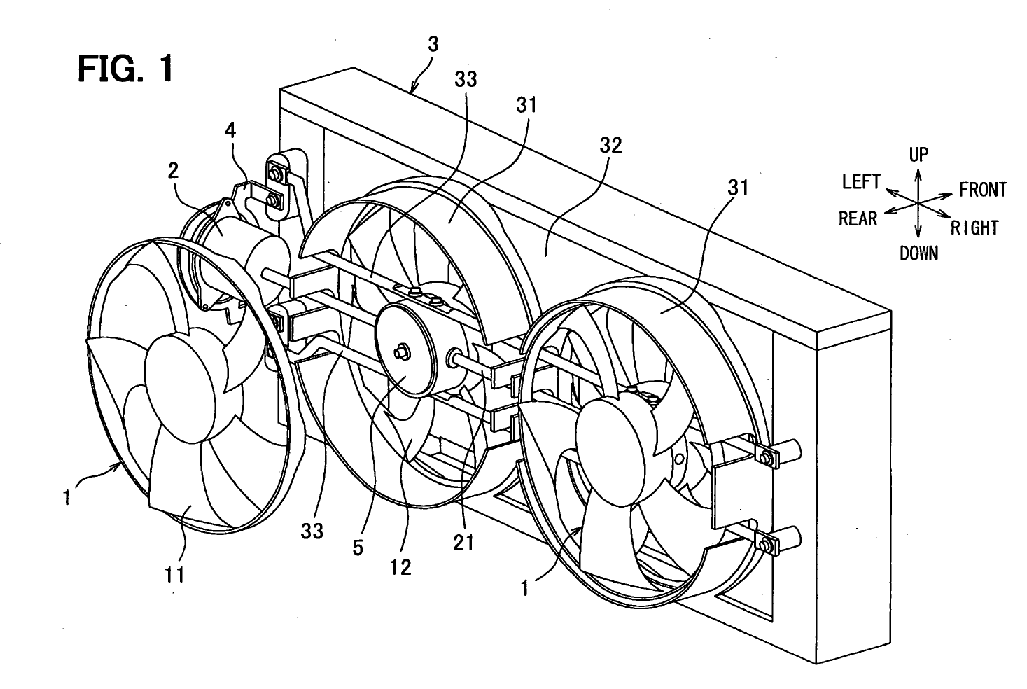

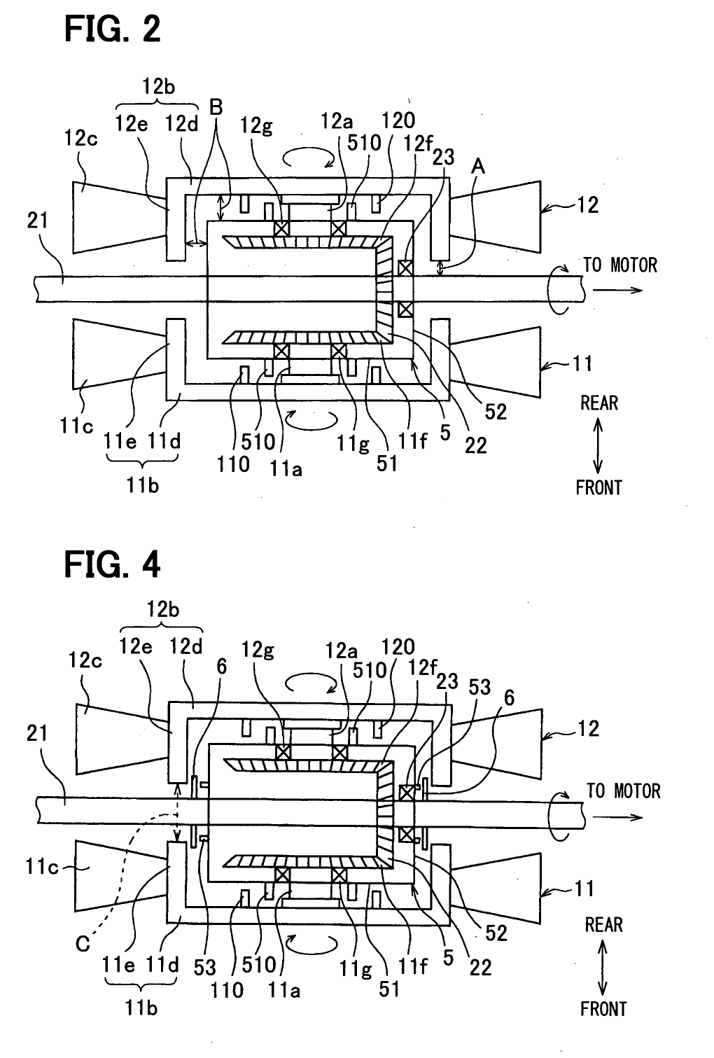

A first embodiment of the present invention will be now described with reference to FIGS. 1 and 2. In the first embodiment, a blower unit of the present invention is typically used for blowing cool air to a heat exchanger such as a radiator and a condenser (refrigerant radiator) mounted on a vehicle. Here, the radiator is a heat exchanger in which engine-cooling water (hot water) from an engine is heat-exchanged with air, and the condenser is a heat exchanger in which refrigerant circulating in a refrigerant cycle is heat-exchanged with air. In the first embodiment, the radiator is located in the vehicle at a vehicle rear side from the condenser, and the blower unit is located to blow air to the radiator and the condenser.

FIG. 1 is a disassembled perspective view showing contrarotating blowers 1 and a fan shroud 3 of the blower unit. In this embodiment, two contrarotating blowers 1 are arranged on a vehicle rear side of the heat exchanger (not shown). The two contrarotating blowers 1 are driven and rotated by a single motor 2.

The fan shroud 3 includes two shroud ring portions 31 each of which has a cylindrical shape (ring shape), and a shroud plate portion 32 connected to rear side portions of the shroud ring portions 31 so as to form a smooth air passage from a rear side of the radiator (not shown) to the shroud ring portions 31. Furthermore, in this embodiment, the shroud ring portions 31 and the shroud plate portion 32 are integrally formed.

The shroud ring portion 31 is formed to have a Venturi type passage in which the contrarotating blower 1 can be freely rotated while a necessary space can be kept between tip ends of blades 11c, 12c of the blower 1 and an inner peripheral surface of the shroud ring portion 31. The blowers 1 are supported by rotation shafts 11a, 12a of the gear boxes 5. In this embodiment, the two blowers 1 are arranged on a surface in a line such that the rotation shafts 11a, 12a of the two blowers 1 are arranged in parallel with each other, as shown in FIG. 1. Therefore, the shroud ring portions 31 are arranged to correspond to the two blowers 1. Furthermore, a motor 2 for driving and rotating the blowers 1 is fixed to a vehicle rear side of the shroud plate portion 32 through a bracket 4.

Next, the structure of the contrarotating blower 1 will be described. Because the structures of the two contrarotating blowers 1 are approximately similar to each other, one contrarotating blower 1 on the side of the motor 2, shown in FIG. 2, will be now described.

As shown in FIG. 2, the contrarotating blower 1 includes a first axial fan 11 located on a vehicle front side with respect to a rotation drive shaft 21 extending from the motor 2, and a second axial fan 12 located on a vehicle rear side with respect to the rotation drive shaft 21. The first axial fan 11 and the second axial fan 12 are located in series, such that rotation shafts 11a, 12a of the axial fans 11, 12 are arranged on the same axial line. The first axial fan 11 is located on a vehicle front side (upstream air side) of the second axial fan 12, for example.

The first axial fan 11 and the second axial fan 12 are located to be rotated reversely from each other. However, both the first axial fan 11 and the second axial fan 12 are set to induce the same air flow. Accordingly, the rotation flow component part in a circumferential direction, generated at an outlet of the first axial fan 11, is reversed by the contra-rotating of the second axial fan 12. Therefore, the dynamic pressure part of the rotation flow, generated at the outlet of the first axial flow fan 11 can be recovered as the static pressure. As a result, a high static pressure can be generated as compared with a general axial fan, thereby increasing an air amount sent from the blower 1 to the heat exchanger.

The first axial fan 11 includes a boss portion 11b, and a plurality of blades 11c arranged radially outside from the boss portion 11b. Similarly, the second axial fan 12 includes a boss portion 12b, and a plurality of blades 12c arranged radially outside from the boss portion 12b. Each of the boss portions 11b, 12b is formed into a one-side opened box shape (e.g., recess shape having approximately U-shaped cross section). The boss portion 11b includes a circular bottom portion 11d, and a side wall portion 11e protruding approximately perpendicularly from the edge portion of the bottom portion 11d. Similarly, the boss portion 12b includes a circular bottom portion 12d, and a side wall portion 12e protruding approximately perpendicularly from the edge portion of the bottom portion 12d.

One end of the rotation shaft 11a is connected to a center portion of the bottom portion 11d, and one end of the rotation shaft 12a is connected to a center portion of the bottom portion 12d. The blades 11c are connected to the outer surface of the side wall portion 11e of the boss portion 11b, and the blades 12c are connected to the outer surface of the side wall portion 12e of the boss portion 12b. In the first embodiment, the first and second axial fans 11, 12 are located, such that recess portions of the boss portions 11b, 12b are opposite to each other, and the end portions of the side wall portions 11e, 12e are opposite to each other, in an axial direction of the rotation shafts 11a, 12a.

Two main gears 22 are fixed to the rotation drive shaft 21 of the motor 2 at positions corresponding to the two contrarotating blowers 1, respectively. As the main gear 22, a screw gear or a bevel gear can be used.

The rotation shafts 11a, 12a of the first and second axial fans 11, 12 are located perpendicularly to the rotation drive shaft 21 of the motor 2. One end of the rotation shaft 11a is connected to the boss portion 11b, and the other end of the rotation shaft 11a is connected to a driven gear 11f. Similarly, one end of the rotation shaft 12a is connected to the boss portion 12b, and the other end of the rotation shaft 12a is connected to a driven gear 12f. The driven gears 11f, 12f are engaged with the main gear 22, such that the rotation driving force of the motor 2 is transmitted to the rotation shafts 11a, 12a of the first and second axial fans 11, 12 and both the first and second axial fans 11, 12 are rotated reversely. As the driven gears 11f, 12f, screw gears or bevel gears can be suitably used.

The rotation shafts 11a, 12a of the first and second axial fans 11, 12 are rotatably supported in the gear box 5 through bearings 11g, 12g, respectively. The gear box 5 is formed to house the driven gears 11f, 12f and the main gear 22. The driven gears 11f, 12f and the main gear 22 are located in the gear box 5, and the rotation drive shaft 21 is rotatably supported in the gear box 5 through a bearing 23.

As shown in FIG. 1, the gear box 5 is attached to stays 33 extending approximately horizontally from one end to the other end of the fan shroud 3. For example, in this embodiment, two parallel stays 33 are located to extend in parallel so as to support the top and bottom ends of each gear box 5.

Next, the blower 1 with the structures of the gear box 5 and the first and second axial fans 11, 12 will be described.

As shown in FIGS. 1 and 2, the gear box 5 is formed into approximately a cylindrical shape. The gear box 5 is located between the boss portions 11b, 12b of the first and second axial fans 11, 12, and is covered by the boss portions 11b, 12b from two sides in an air flow direction of the fans 11, 12. The gear box 5 includes a first wall surface 51 that is formed into a cylindrical shape to be opposite to the bottom portions 11d, 12d of the boss portions 11b, 12b, and a second wall surface 52 that is formed to be opposite to the side wall portions 11e, 12e of the boss portions 11b, 12b.

As shown in FIG. 2, circular first protrusion walls 110, 120 are formed on inner surfaces of the bottom portions 11d, 12d of the boss portions 11b, 12b to protrude from the bottom portions 11d, 12d toward the first wall surface 51 of the gear box 5. Each of the first protrusion walls 110, 120 is formed into a circular shape around the rotation shaft 11a, 12a, respectively, to be approximately concentric with the circular bottom portion 11d, 12d. The first protrusion walls 110, 120 are provided to form a labyrinth structure with a passage having at least a bet portion.

On the other hand, circular second protrusion walls 510 are formed on an outer surface of the first wall surface 51 of the gear box 5 to protrude radial outside toward the bottom portions 11d, 12d of the boss portions 11b, 12b. Each of the second protrusion walls 510 is formed into a circular shape around the rotation shafts 11a, 12a. Furthermore, the circular shape of the second protrusion wall 510 has a diameter smaller than that of the first protrusion wall 110, 120. Therefore, in this embodiment, the first protrusion walls 110, 120 and the second protrusion walls 510 are located approximately concentrically so as to form a labyrinth structure. This labyrinth structure prevents foreign materials entered from the clearance A from moving toward the rotation shafts 11a, 12a, thereby preventing the foreign materials from being introduced into the gear box 5 through clearances between the gear box 5 and the rotation shafts 11a, 12a.

As the clearance A between the rotation drive shaft 21 and ends of the side wall portions 11e, 12e of the boss portions 11b, 12b is made smaller, an introduction of foreign materials such as water, flying stones and dust, into the gear box 5 through the clearance A, can be made smaller. However, when the clearance A is made smaller, the boss portions 11b, 12b may contact the rotation drive shaft 21 by misalignment due to assemble accuracy and dimension accuracy, for example, so rotation function of the blower 1 may be deteriorated. Accordingly, in this embodiment, the clearance A is set to be larger than 0 and not larger than 10 mm. When the clearance A is set about in a range of 3 mm and 6 mm, the rotation function of the blower 1 can be improved while the entering of foreign materials into the gear box 5 through the clearance A can be effectively reduced.

In addition, as a clearance B between the boss portions 11b, 12b and the gear box 5 is made smaller, an introduction (entering) of foreign materials such as water, flying stones and dust, into the gear box 5 can be made smaller. However, when the clearance B is made too smaller, the boss portions 11b, 12b may contact the gear box 5 by misalignment due to assemble accuracy and dimension accuracy, for example, so rotation function of the blower 1 may be deteriorated. Accordingly, in this embodiment, the clearance B is set to be larger than 0 and not larger than 10 mm. When the clearance B is set about in a range of 3 mm and 6 mm, the rotation function of the blower 1 can be improved while the entering of foreign materials can be effectively reduced.

As described above, according to the first embodiment, the main gear 22 and the driven gears 11f, 12f are accommodated in the gear box 5, and the gear box 5 is covered by the boss portions 11b, 12b from both sides in the air flow direction. Therefore, it can reduce the foreign materials introduced into the main gear 22 and the driven gears 11f, 12f.

Furthermore, because the labyrinth structure is formed between the boss portions 11b, 12b and the gear box 5, it can restrict foreign materials from entering into the gear box 5 through the clearances between the rotation shafts 11a, 12a and the gear box 5. As a result, it can effectively reduce foreign materials introduced into the main gear 22 and the driven gears 11f, 12f.

### Second Embodiment

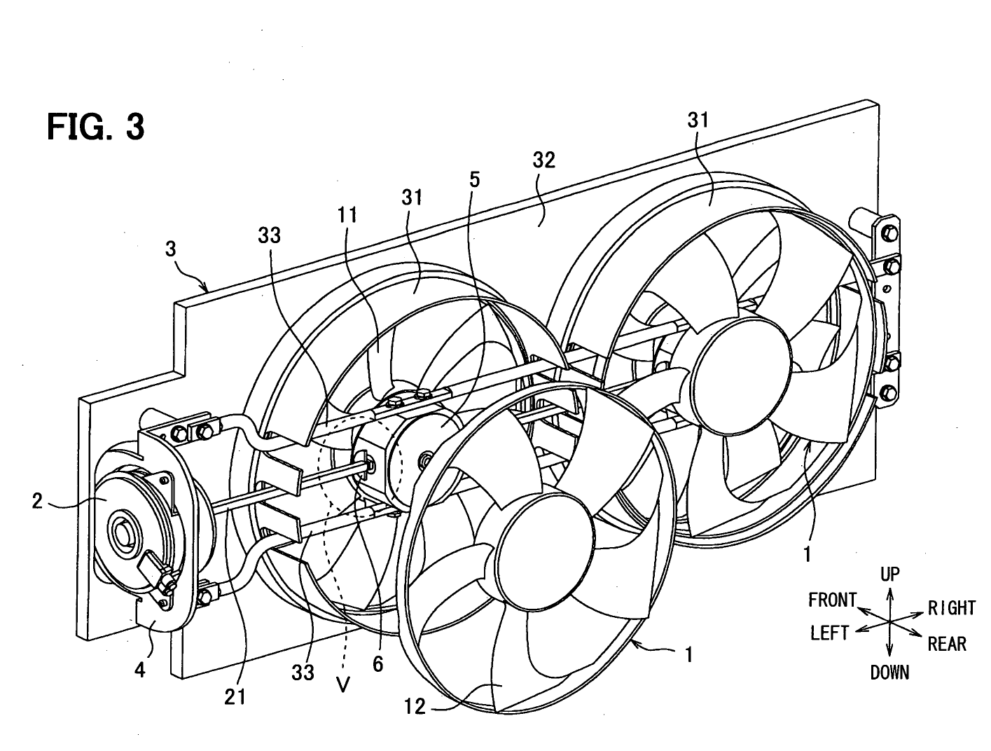

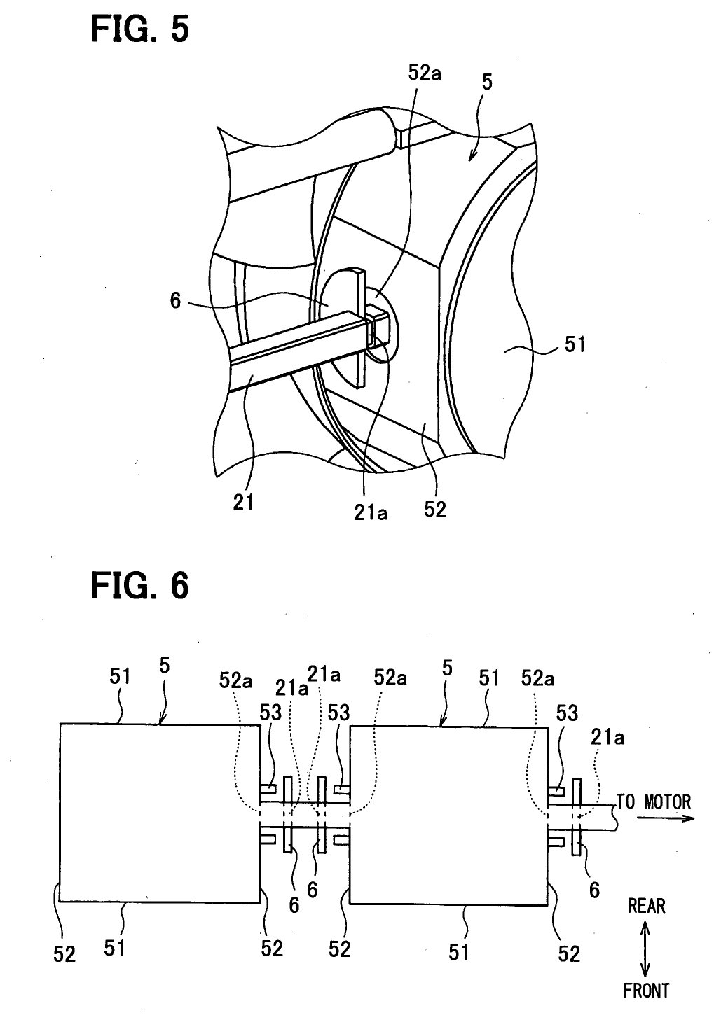

A second embodiment of the present invention will be now described with reference to FIGS. 3 to 8. In the second embodiment, the parts having the same functions as those of the first embodiment are indicated as the same reference numbers, and explanation thereof is omitted. FIG. 3 is a perspective view showing two contrarotating blowers 1 of the second embodiment and the fan shroud 3. In the second embodiment, a cover plate 6 (foreign material preventing member) is provided in the blower 1 so as to prevent foreign material from entering from the clearance between the boss portion 11b, 12b and the rotation drive shaft 21. In this embodiment, the cover plate 6 for preventing foreign material from entering is formed into approximately a circular shape. However, in FIGS. 3 and 5, a cut shape of the cover plate 6 cut in half in a vehicle up-down direction is indicated.

FIG. 5 is an enlarged view showing the part V indicated in FIG. 3, and FIG. 6 is a partial sectional top view showing the gear boxes 5 and the rotation drive shaft 21 without indicating the inner structures of the gear boxes 5.

As shown in FIGS. 5 and 6, a through hole 52a is provided in the second wall surface 52 of the gear box 5, for penetrating through the rotation drive shaft 21. Furthermore, the cover plate 6 (foreign material preventing member) is attached to the rotation drive shaft 21 while being spaced from the second wall surface 52 (through hole 52a) of the gear box 5. In the second embodiment, the cover plate 6 is made of an elastic material (e.g., rubber) to be elastically deformable, and is formed separately from the rotation drive shaft 21.

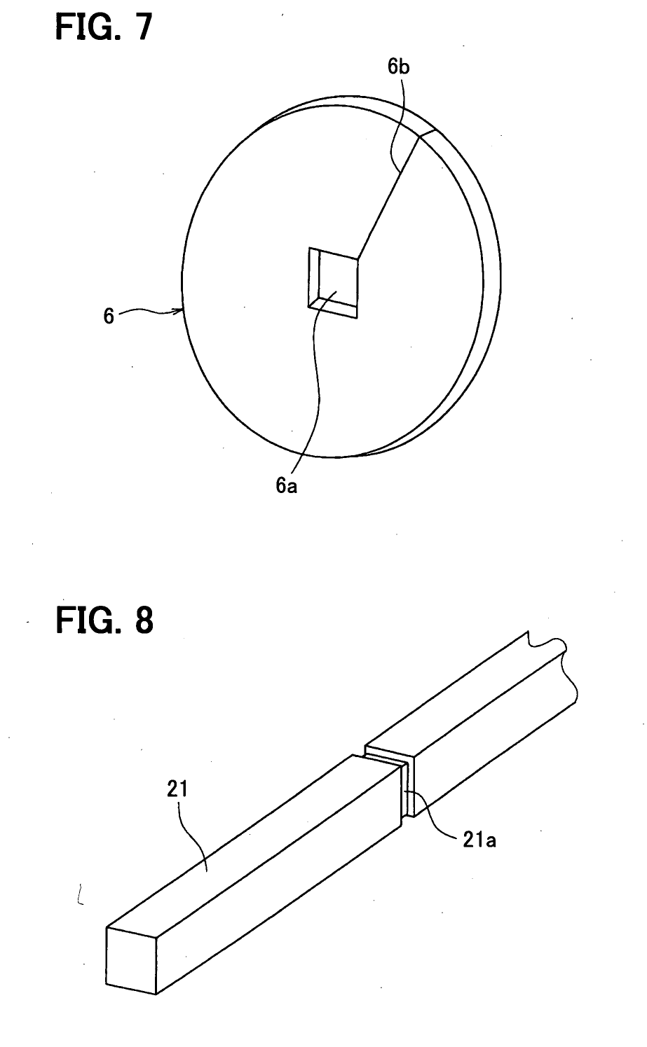

FIG. 7 is a perspective view showing the cover plate 6 according to the second embodiment. As shown in FIG. 7, the cover plate 6 is formed into a doughnut shape having a through hole 6a at its center portion. The rotation drive shaft 21 is inserted into the through hole 6a of the cover plate 6. A cut portion 6b having a cut line extending from an outer peripheral end portion of the cover plate 6 to the through hole 6a is formed in the cover plate 6, so that the rotation drive shaft 21 is press-fitted into the through hole 6a through the cut portion 6b.

As shown in FIG. 4, in the second embodiment, the diameter of the cover plate 6 is set larger than a distance C between ends of the side wall portions 11e, 12e of the boss portions 11b, 12b. Furthermore, each of the cover plates 6 is located between the second wall surface 52 of the gear box 5 and the side wall portion 11e, 12e of the boss portion 11b, 12b, in an axial direction of the rotation drive shaft 21.

FIG. 8 is a perspective view showing the rotation drive shaft 21 according to the second embodiment. As shown in FIG. 8, a groove portion 21a is formed in the rotation drive shaft 21 at apposition corresponding to the through hole 6a of the cover plate 6. Therefore, the groove portion 21a is used for a position determination of the cover plate 6 when the cover plate 6 is assembled to the rotation drive shaft 21, and is also used for preventing a movement of the cover plate 6 in the axial direction of the rotation drive shaft 21. In this embodiment, the groove portion 21a of the rotation drive shaft 21 is pressed from the cut portion 6b into the through hole 6a of the cover plate 6, to be engaged with the through hole 6a of the cover plate 6. With this, the cover plate 6 is assembled to the rotation drive shaft 21 to be fixed to the rotation drive shaft 21.

As shown in FIGS. 4 and 6, a circular protrusion plate 53 is formed to protrude toward the cover plate 6 at a radial outside of the through hole 52a formed in the second wall surface 52 of the gear box 5, so as to form a labyrinth structure. For example, the protrusion plate 53 has a circular shape approximately concentrically around an axial center of the rotation drive shaft 21. In this embodiment, the circular shape of the protrusion plate 53 has a diameter that is larger than the diameter of the through hole 52a of the second wall surface 52 and is smaller than the diameter of the cover plate 6, for example. Furthermore, the protrusion plate 53 has a protrusion end spaced from the cover plate 6 so as to form a clearance therebetween.

Because the cover plate 6 is located to cover the through hole 52a of the gear box 5 while being spaced from the second wall surface 52 having the through hole 52a in the axial direction of the shaft 21, the cover plate 6 restricts the foreign material from entering into the gear box 5 through the through hole 52a. Furthermore, because the cover plate 6 is fixed to the shaft 21, it can restrict liquid adhering to the shaft 21 from moving into the gear box 5 along the rotation drive shaft 21. Therefore, it can prevent foreign material from being introduced to the main gear 22 and the driven gears 11f, 12f.

In the second embodiment, the protrusion plates 53 for forming the labyrinth structure are formed to protrude in the axial direction of the rotation drive shaft 21 from an outer surface of the gear box 5 toward the cover plate 6 at an outer side of the through hole 52a. Each of the protrusion plates 53 is formed at the outer side of the through hole 52a to protrude from the second wall surface 52 of the gear box 5 toward the cover plate 6 in the axial direction of the rotation drive shaft 21, so as to form the labyrinth structure therebetween. Therefore, the labyrinth structure restricts foreign materials from entering into the gear box 5, thereby preventing foreign materials from being introduced to the main gear 22 and the driven gears 11f, 12f.

In the second embodiment, the groove portion 21a is provided in the shaft 21, and the cover plate 6 made of an elastic material such as rubber is provided with the cut portion 6b. Therefore, by pressing the groove portion 21a of the rotation drive shaft 21 from the cut portion 6b into the through hole 6a of the cover plate 6, the cover plate 6 can be easily attached to the rotation drive shaft 21. Thus, assembling performance of the blower 1 can be improved, while foreign material entering to the main gear 22 and the driven gears 11f, 12f can be effectively reduced.

In the second embodiment, the other parts can be made similar to those of the above-described first embodiment.

### Third Embodiment

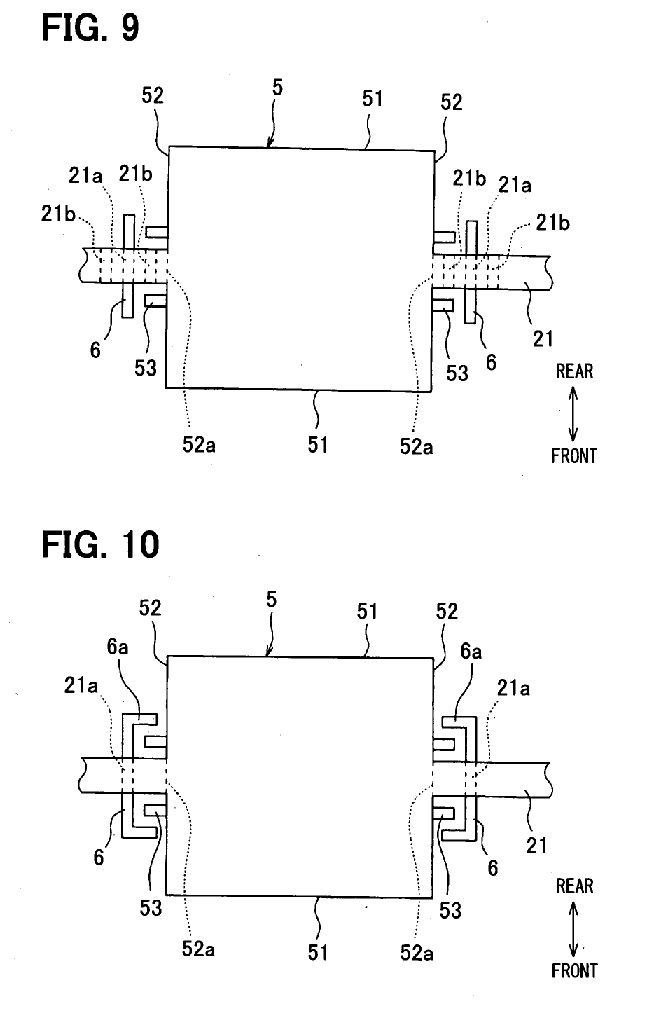

A third embodiment of the present invention will be described with reference to FIG. 9. In the third embodiment, different parts different from the above-described first or second embodiment will be mainly described. In the third embodiment, the groove portion 21a described in the second embodiment is used as a first groove portion 21a, and a plurality of second groove portions 21b (e.g., two groove portions in this embodiment) are formed in the rotation drive shaft 21 at positions near the first groove portion 21a. In this embodiment, the first groove portion 21a and the second groove portions 21b are arranged at equal distance to have approximately the same shape.

The fan diameters of the axial fans 11, 12 or the dimension between the two gear boxes 5 may be different based on vehicle kinds or the like. Accordingly, if a single groove portion (first groove portion 21a) is formed, the single groove portion may need to be provided at different positions in accordance with different vehicle kinds. With respect to this, in the third embodiment, because the second groove portions 21b are provided in the rotation drive shaft 21 in addition to the first groove portion 21a, the rotation drive shaft 21 can be used in common for different kinds of vehicles, thereby improving productivity of the blower 1.

In the third embodiment, the plural second groove portions 21b, which are not directly used to fix the cover member 6, are provided in the rotation drive shaft 21. Accordingly, even if liquid adheres on the rotation drive shaft 21, the liquid is difficult to be moved into the gear box 5 due to the plural groove portions 21b, thereby restricting the liquid from entering into the gear box 5. As a result, it can further reduce foreign material introduced into the gear box 5.

In the third embodiment, the other parts can be made similar to those of the above-described second embodiment.

### Fourth Embodiment

A fourth embodiment of the present invention will be now described with reference to FIG. 10. In the fourth embodiment, different parts different from the above-described fourth embodiment will be mainly described. In the fourth embodiment, the shape of the cover plate 6 is changed as compared with the above-described second embodiment or the third embodiment. In the fourth embodiment, the cover plate 6 is provided with a protrusion wall portion 6a protruding toward the gear box 5, as shown in FIG. 10. For example, the protrusion wall portion 6a protrudes from a flat surface of the cover plate 6 approximately perpendicular to the flat surface of the cover plate 6.

In this embodiment, the protrusion wall portion 6a is formed integrally with the cover plate 6 at a position outside of the protrusion wall 53, to have a clearance between the protrusion wall portion 6a and the protrusion wall 53. A protrusion tip end portion of the protrusion wall portion 6a and a protrusion tip end portion of the protrusion wall 53 are overlapped in a direction perpendicular to the axial direction of the rotation drive shaft 21 while a clearance is formed between the protrusion wall 53 and the protrusion wall portion 6a of the cover plate 6. Therefore, a labyrinth structure is formed by the protrusion wall portion 6a of the cover plate 6 and the protrusion wall 53, thereby effectively reducing foreign materials entering to the main gear 22 and the driven gears 11f, 12f.

In the fourth embodiment, the other parts can be made similar to those of the above-described second embodiment or the third embodiment.

### Fifth Embodiment

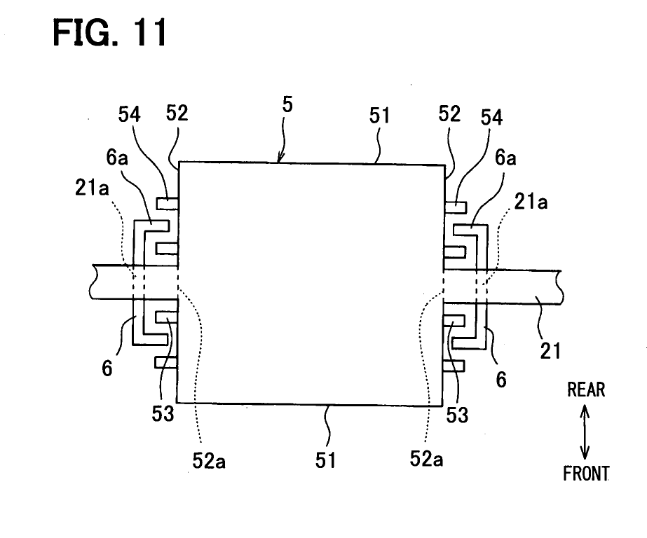

A fifth embodiment of the present invention will be now described with reference to FIG. 11. In the fifth embodiment, different parts different from the fourth embodiment will be now described. In the fifth embodiment, the protrusion wall 53 described in the fourth embodiment is used as a first protrusion wall 53, and a second protrusion wall 54 is provided radially outside of the protrusion wall portion 6a of the cover plate 6.

FIG. 9 is a partial sectional top view showing the gear box 5 and the rotation drive shaft 21 while the inner structure of the gear box 5 is omitted.

As shown in FIG. 9, the protrusion wall portion 6a of the cover plate 6 is positioned radially outside of the first protrusion wall 53, and the second protrusion wall 54 is provided on the second wall surface 52 of the gear box 5 radially outside of the protrusion wall portion 6a of the cover plate 6. The second protrusion wall 54 is formed approximately in a circular shape around the axial center line of the rotation drive shaft 21, and protrudes from the second wall surface 52 of the gear box 5 toward the cover plate 6. For example, the first protrusion wall 53 and the second protrusion wall 54 are arranged concentrically with each other.

The circular shape of the second protrusion wall 54 has a diameter larger than that of the first protrusion wall 53 so as to form a clearance between the first protrusion wall 53 and the second protrusion wall 54. The protrusion wall portion 6a of the cover plate 6 is located in the clearance between the first protrusion wall 53 and the second protrusion wall 54 so as to form a labyrinth structure by the protrusion walls 53, 54 and the cover plate 6. The first and second protrusion walls 53, 54 and the protrusion wall portion 6a of the cover plate 6 are overlapped in a radial direction of the shaft 21 while clearances are formed between the first and second protrusion walls 53, 54 and the protrusion wall portion 6a of the cover plate 6. Therefore, the first and second protrusion walls 53, 54 and the protrusion wall portion 6a of the cover plate 6 construct the labyrinth structure in the fifth embodiment. Accordingly, it can restrict foreign materials from entering to the main gear 22 and the driven gears 11f, 12f.

In the fifth embodiment, the other parts can be similar to those of the above-described second embodiment, third embodiment or the fourth embodiment.

### Other Embodiments

Although the present invention has been fully described in connection with the preferred embodiments thereof with reference to the accompanying drawings, it is to be noted that various changes and modifications will become apparent to those skilled in the art.

For example, in the above-described embodiments, the two contrarotating blowers 1 are arranged on the same plane to be driven by the single motor 2 such that the rotation shafts 11a, 12a of the blowers 1 are located in parallel with each other. However, a single contrarotating blower 1 may be used, or plural blowers 1 more than two may be arranged on the same plane such that the rotation shafts 11a, 12a of the blowers 1 are in parallel with each other.

In the above-described embodiments, the double contrarotating fans are used for the blower 1. However, a series of axial fans may be used for the blower 1.

In the above-described embodiments, the cover plate 6 (foreign material prevention member) is made of rubber; however, can be made of the other material such as resin or metal. When the cover plate 6 is made of metal, the cover plate 6 is assembled to the rotation drive shaft 21 by press-fitting.

In the above-described first embodiment, the labyrinth structure between the boss portion 11b (12b) and the gear box 5 is constructed with both the first and second protrusion walls 110 (120) and 510. However, the labyrinth structure between the boss portion 11b (12b) and the gear box 5 may be constructed with one of the first and second protrusion walls 110 (120) and 510, or protrusion walls more that two.

Furthermore, in the above-described first embodiment, the diameter of the circular shape of the second protrusion wall 510 is made smaller than the diameter of the circular shape of the first protrusion wall 110, 120. However, the diameter of the circular shape of the second protrusion wall 510 may be made larger than the diameter of the circular shape of the first protrusion wall 110, 120. Furthermore, each of the first protrusion wall 110, 120 and the second protrusion wall 510 can be formed into a shape other than the circular shape.

In the above-described second embodiment, the diameter of the circular cover plate 6 is made larger than the distance C between the ends of the side wall portions 11e, 12e of the boss portion 11b, 12b. However, the diameter of the circular cover plate 6 may be made equal to or smaller than the distance C between the ends of the side wall portions 11e, 12e.

In the above-described second to fifth embodiments, the protrusion wall 53 is provided on the second wall surface 52 of the gear box 5 to protrude from the second wall surface 52 toward the cover plate 6. However, the protrusion wall 53 may be not provided. Similarly, the protrusion wall 54 may be not provided in the fifth embodiment.

In the above-described embodiments, the motor 2 is fixed to the fan shroud 3 through the bracket 4, and the gear box 5 is fixed to the fan shroud 3 through the stay 33. However, the motor 2 may be directly fixed to the fan shroud 3 without the bracket 4, and the gear box 5 may be directly fixed to the fan shroud 3 without the stays 33.

In the above-described third embodiment, the two second groove portions 21b are provided relative to the single first groove portion 21a. However, the second groove portion 21b may be provided at one position or three or more positions.

Such changes and modifications are to be understood as being within the scope of the present invention as defined by the appended claims.

What is claimed is:

1. A blower comprising:
two contrarotating axial fans which are located to be rotated reversely with each other in accordance with rotations of its rotation shafts arranged on an axial line;
a motor for rotating the axial fans;
a gear portion through which a rotation drive shaft of the motor is coupled to the rotation shafts of the axial fans; and
a gear box in which the gear portion is housed, wherein:
each of the axial fans includes a boss portion having a recess shape opened in an axial direction of the axial fan, and a plurality of blades located radial outside of the boss portion;
the axial fans are located such that the recess shapes of the boss portions are opposite to each other; and
the gear box is located between the boss portions of the axial fans, and is covered by the boss portions from two sides in an air flow direction of the axial fans.

2. The blower according to claim 1, wherein:
the rotation drive shaft is located between the axial fans and extends perpendicularly to the axial line of the rotation shafts of the axial fans;
the gear portion includes a main gear connected to the rotation drive shaft of the motor, and two driven gears that are engaged with the main gear and connected to the rotation shafts of the axial fans;
the driven gears are engaged with the main gear so as to rotate the axial fans reversely with each other.

3. The blower according to claim 2, wherein:
each of the boss portions is spaced from the rotation drive shaft to have a first clearance between an end portion of the boss portion and the rotation drive shaft; and
the first clearance is larger than 0 and is equal to or smaller than 10 mm.

4. The blower according to claim 3, wherein the first clearance is approximately in a range between 3 mm and 6 mm.

5. The blower according to claim 1, wherein:
each of the boss portions is spaced from the gear box to have a second clearance between the boss portion and the gear box; and
the second clearance is larger than 0 and is equal to or smaller than 10 mm.

6. The blower according to claim 5, wherein the second clearance is approximately in a range between 3 mm and 6 mm.

7. The blower according to claim 1, further comprising
at least one protrusion wall portion located around the rotation shaft of the axial fan to protrude approximately in a circular shape from at least one of the boss portion and the gear box toward the other one of the boss portion and the gear box.

8. The blower according to claim 1, further comprising
a first protrusion wall portion protruding approximately in a circular shape around the rotation shaft of the axial fan from the boss portion toward gear box; and
a second protrusion wall portion protruding approximately in a circular shape around the rotation shaft of the axial fan from the gear box toward the boss portion, approximately concentrically with the circular shape of the first protrusion wall,
wherein the first protrusion wall portion and the second protrusion wall portion have different diameters in the circular shapes to form a clearance therebetween.

9. The blower according to claim 1, wherein the gear box has a through hole for penetrating through the rotation drive shaft, the blower further comprising
a cover plate located to the rotation drive shaft to cover the through hole while being separated from the through hole of the gear box in an axial direction of the rotation drive shaft.

10. The blower according to claim 9, further comprising
a protrusion wall provided on the gear box, to protrude approximately in a circular shape around the through hole from the gear box toward the cover plate.

11. The blower according to claim 9, wherein:
the cover plate has a through hole for penetrating through the rotation drive shaft;
the rotation drive shaft has a groove portion at a position corresponding to the through hole of the cover plate; and
the groove portion of the rotation drive shaft is engaged with the through hole of the cover plate so as to fix the cover plate to the rotation drive shaft.

12. The blower according to claim 11, wherein:
the cover plate is made of an elastic material; and
the cover plate has a cut portion extending from an outer peripheral end of the cover plate to the through hole.

13. The blower according to claim 9, wherein:
the cover plate has a through hole for penetrating through the rotation drive shaft;
the rotation drive shaft has a first groove portion at a position corresponding to the through hole of the cover plate, and at least one second groove portion at an axial position different from the first groove portion; and
the first groove portion of the rotation drive shaft is engaged with the through hole of the cover plate so as to fix the cover plate to the rotation drive shaft.

14. A blower comprising:
at least one axial fan;
a motor for driving and rotating the axial fan;
a gear portion through which a rotation drive shaft of the motor is coupled to a rotation shaft of the axial fan;
a gear box in which the gear portion is housed, the gear box having a through hole for penetrating through the rotation drive shaft; and
a cover plate located to the rotation drive shaft to cover the through hole while being separated from the through hole of the gear box in an axial direction of the rotation drive shaft.

15. The blower according to claim 14, further comprising
a protrusion wall provided on the gear box, to protrude approximately in a circular shape around the through hole from the gear box toward the cover plate.

16. The blower according to claim 14, wherein:
the cover plate has a through hole for penetrating through the rotation drive shaft;
the rotation drive shaft has a groove portion at a position corresponding to the through hole of the cover plate; and
the groove portion of the rotation drive shaft is engaged with the through hole of the cover plate so as to fix the cover plate to the rotation drive shaft.

17. The blower according to claim 16, wherein:
the cover plate is made of an elastic material; and
the cover plate has a cut portion extending from an outer peripheral end of the cover plate to the through hole.

18. The blower according to claim 14, wherein:
the cover plate has a through hole for penetrating through the rotation drive shaft;
the rotation drive shaft has a first groove portion at a position corresponding to the through hole of the cover plate, and at least one second groove portion at an axial position different from the first groove portion;
the second groove portion has the same shape as the first groove portion; and
the first groove portion of the rotation drive shaft is engaged with the through hole of the cover plate so as to fix the cover plate to the rotation drive shaft.

19. The blower according to claim 14, wherein:
the at least one axial fan is constructed with two contrarotating axial fans having its rotation shafts arranged on the same axial line;
each of the axial fans includes a boss portion having a recess shape opened in an axial direction of the axial fan, and a plurality of blades located radial outside of the boss portion;
the axial fans are located such that the recess shapes of the boss portions are opposite to each other;
the gear box is located between the boss portions of the axial fans, and is covered by the boss portions from two sides in an air flow direction of the axial fans; and
the cover plate is located between the gear box and the boss portion in an axial direction of the rotation drive shaft.

20. The blower according to claim 1 being used for a vehicle, wherein the axial fan is for blowing air to a heat exchanger mounted on the vehicle.
